(19) United States
(12) Patent Application Publication
(10) Pub. No.: US 2010/0289348 A1
(43) Pub. Date: Nov. 18, 2010

(54) AXIAL FLOW MACHINE

(75) Inventors: Andreas Gruendl, Starnberg (DE); Bernhard Hoffmann, Starnberg (DE); Reinhard Rasch, Hechendorf (DE)

Correspondence Address: HISCOCK & BARCLAY, LLP, 2000 HSBC PLAZA, 100 Chestnut Street, ROCHESTER, NY, 14604-2404, US

(73) Assignee: Compact Dynamics GmbH, Starnberg (DE)

(21) Appl. No.: 12/782,011

(22) Filed: May 18, 2010

(30) Foreign Application Priority Data
May 18, 2009 (DE) DE102009 021703.7

(51) Int. Cl. H02K 9/22; H02K 1/12; H02K 9/19

(52) U.S. Cl. 310/54; 310/257; 310/64

(57) ABSTRACT

In an electrical axial flow machine, comprising a stator and a rotor, wherein either the stator comprises a coil arrangement and the rotor is provided with permanent magnet elements, or wherein the rotor comprises a coil arrangement and the stator is provided with permanent magnet elements, the stator is arranged spaced from the rotor under the formation of an air gap, each of the magnetic flux yokes has several neighbouring magnetic flux poles, the coil arrangement has at least one hollow cylindrical winding which is at least partially encompassed by magnetic flux yokes, the magnetic flux poles each have an outside which is oriented to the permanent magnet elements beyond the air gap, neighbouring permanent magnet elements in the circumferential direction have an alternating magnetic orientation towards the air gap, at least several of the magnetic flux poles are in certain positions of the rotor relative to the stator at least partially oriented in alignment with the permanent magnet elements, the magnetic flux yokes are formed from several ring cylinder segments, one support disk each is arranged between neighbouring magnetic flux yokes for the ring cylinder segments of the magnetic flux yokes in the direction of a longitudinal centre axis of the magnetic flux yokes, with the support disk comprising means for the mechanic positioning of at least two ring cylinder segments, forms a thermal path to a heat sink and has an electrically insulating effect.

### BACKGROUND

An axial flow machine is presented in the form of an electrical permanent-field machine with improved manufacturability, higher efficiency, and lower costs than known axial flow machines. In particular, the invention relates to an axial flow machine with a stator and a rotor, one of which, e.g. the stator, has a coil for the generation of the magnetic field, and the other one, e.g. the rotor, has permanent magnet elements for the interaction with the generated magnetic field.

### DEFINITIONS OF TERMS

The term “electrical machine” as used herein covers both motor and generator operated machines as well as machines which are operated alternately between these two modes. For the arrangement presented herein, it is irrelevant whether such a machine is designed as an internal rotor machine or an external rotor machine.

### STATE OF THE ART

DE 195 47 159 A1 shows a transversal flow machine with conductor rings which are encompassed on three sides by U-shaped, soft magnetic bodies, with a magnetic circuit of soft and/or hard magnetic parts being closed periodically. These parts are separated from the respective U-shaped, soft magnetic body by two air gaps which are provided radially outside the conductor rings. The magnetically active parts of the rotor or stator are partially arranged axially within the ends of the U-shaped soft magnetic bodies.

From EP 0 952 657 A2, a transversal flow machine with a stator arrangement in a stator housing is known, in which a pole system with a U-shaped cross-section, which extends in the rotating direction is arranged. In the recess between the legs of the U-shaped cross-section, an annular winding is arranged which extends in the rotating direction. A rotor arrangement comprises rows of alternately arranged permanent magnets and soft iron flux return elements. On the stator side, a support ring each is provided between the annular winding and the rotor arrangement, which comprises recesses in both marginal areas for the accommodation of teeth of the pole system, which project in the direction of the rotor arrangement. The support ring serves to stabilise the pole system and the annular coil. Each pole system consists of an annular pole yoke and two pole rings which are arranged adjacent in the lateral areas of same. The pole rings are provided with incisions or slots in the pole yoke-side marginal areas.

From DE 39 04 516 C1, an electrical permanent-field machine is known, the pole rings of which with formed pole teeth, external stator, and internal stator are to be assembled from segmental core disks each of which consisting of mutually insulated disks. The segmental core disks extend e.g. over one sixth of the circumference.

From DE 10 2005 036 041 A1, an electrical permanent-field machine is known, with a stator and a rotor, wherein either the stator comprises a coil arrangement and the rotor is provided with permanent magnet elements, or the rotor comprises a coil arrangement and the stator is provided with permanent magnet elements. Between the stator and the rotor an air gap is formed which is defined by the permanent magnet elements and by magnetically conductive teeth of the stator at certain positions, which are aligned with them. The coil arrangement has at least one hollow cylindrical winding. This stator or its parts may be constructed from laminations or lamination portions, or from iron particles which are pressed and/or sintered into the appropriate shaped. Combinations of these two variants are also described, wherein transition areas of radially oriented lamination portions to axially oriented lamination portions are formed from pressed or sintered iron particles.

From DE 699 27 564 T2, a claw-pole dynamo for a bicycle is known, the stator yoke of which is formed from pure iron magnetic steel laminations.

### Underlying Problem

The object is to provide a compact and highly efficient electrical machine which has a high power density with an optimised construction for series production.

### Solution

In order to achieve this object, an electrical axial flow machine with the features of patent claim 1 is proposed herein. This axial flow machine has a stator and a rotor. Either the stator is provided with a coil arrangement and the rotor is provided with permanent magnet elements, or the rotor has a coil arrangement and the stator is provided with permanent magnet elements. The stator is arranged spaced from the rotor under the formation of an air gap. Each of the magnetic flux yokes has (inner or outer) lateral areas with magnetic flux poles. The coil arrangement may have at least one hollow cylindrical winding which is at least partially encompassed by magnetic flux yokes. The winding may have one or several turns. The magnetic flux poles have one each outer (or inner) side which is oriented to the permanent magnet elements beyond the air gap. Neighbouring permanent magnet elements in the circum-ferential or rotational direction of the rotor may be oriented to the air gap in a magnetically alternating way. In several positions of the rotor relative to the stator at least several of the magnetic flux poles may align at least partially with the permanent magnet elements. The magnetic flux yokes are formed from at least one or several ring cylinder segments. One support disk each made from a material with good heat conductivity is provided in the direction of a longitudinal centre axis of the magnetic flux yokes between neighbouring magnetic flux yokes. The one or each support disk comprises means for the mechanical positioning of at least two ring cylinder segments and forms a thermal path to a heat sink. An insulating layer for the electrical insulation is arranged between the support disk and each ring cylinder segment positioned thereon.

### ADVANTAGES, EMBODIMENTS, AND DEVELOPMENTS

Compared to known axial flow machines, this arrangement is advantageous in that it is very compact, mechanically very stable, and highly efficient because the support disk(s) provide for a good heat dissipation of the magnetic flux-conductive parts of the yoke and indirectly also of the coil arrangement. The forces which are due to the magnetic force as well as the torque which is generated by the rotation of the rotor may also be introduced into the support disk. Moreover, the segmental ring portions of the magnetic flux yoke require less manufacturing expenditures than complete rings with a large diameter. The segmentation may also reduce the generation of eddy current. The insulating layer may either be applied on the support disk or on the ring cylinder segment, or be provided between the two components as a layer which is not adhering to either component.

In the case of small diameter rings (e.g. ranging from a few centimetres to approx. 15 cm or 20 cm) it is also possible to form the magnetic flux yoke as a single continuous ring, if required with an interruption along its circumference.

The segmented ring portions of the magnetic flux yoke may be arranged around the outer wall or the inner wall of a magnetically non-effective tube (e.g. made from aluminium). The heat sink, e.g. in the form of a fluid cooling system may be provided at the respective other wall (i.e. the inner wall or the outer wall, respectively), wherein hydrocarbon (e.g. oil or alcohol), water, air or the like flow through one or several appropriately shaped channels.

Each support disk may be formed as a continuous circular disk from a material with good heat conductivity, such as aluminium or the like. One aspect is that the support disks are made from a material which is magnetically non-effective or only slightly effective. Another aspect may be that the support disks are arranged between two magnetic flux yokes, each of which encompassing different coil arrangements. In addition, a support disk each may be provided at both end faces of the magnetic flux yokes, which in this case is connected with one only magnetic flux yoke.

Each support disk may—by suitable shaping and/or by other measures—be arranged on a carrier secured against rotation. The carrier may be a magnetically non-effective tube onto which the support disk (also made from a magnetically non-effective material) may be shrunk or otherwise secured against rotation. As means for the mechanical positioning of the ring cylinder segments on the support disk recesses, projections, or indentation for a non-positive and/or positive connection may be provided which are formed for cooperation with correspondingly shaped means at the ring cylinder segments. The support disk may be profiled in the radial, but also in the circumferential direction. In a variant, the support ring is of greater thickness at the edge closer to the carrier tube than at the edge remote from the carrier tube.

In one variant, the heat sink may be arranged in the carrier (tube) and be designed as a fluid cooling system, as a Peltier element arrangement, or the like.

Each of the ring cylinder segments may comprise a mounting place for at least one portion of the respective support disk. The mounting place in this case is dimensioned and arranged at the ring cylinder segment in such a manner that a cooling down of the ring cylinder segment is enabled. The magnetic flux along the direction of a longitudinal centre axis of the magnetic flux yokes through these is at least essentially unaffected.

The support disk covers approx. 10% to approx. 80%, preferably approx. 25% to approx. 40% of the radial extension of the ring cylinder segment in the radial direction.

Each of the ring cylinder segments may comprise at least one end face (oriented in the axial direction des magnetic flux yoke) which faces at least one of the other ring cylinder segments, wherein the/each end face may comprise a step, so that with ring cylinder segments facing each other, a space is defined between the respective end faces.

Furthermore, each of the ring cylinder segments may comprise two (oriented in the circumferential direction of the magnetic flux yoke) lateral surfaces which face at least one of the other ring cylinder segments in the circumferential direction of the magnetic flux yoke, with the lateral surfaces of two adjacent ring cylinder segments being electrically insulated against each another.

For an at least partial encompassing of the coil arrangement, ring cylinder segments which are oriented towards one another may partially overlap with the respective end faces in the circumferential direction of the magnetic flux yokes. Circular cylinder segments which are oriented towards one another are to be understood as those whose respective magnetic flux poles are in an offset engagement with each other. This essentially completely precludes the occurrence of induced currents in the circumferential direction of the stator or of a significant axial magnetic flux through the support disks, respectively. Each magnetic flux yoke may be made as a single piece or a multi-part component of e.g. two, three, four, five, six, seven, or eight etc. portions from pure iron laminations with a material thickness between approx. 1.5 mm and approx. 5 mm, with any intermediate values being considered as disclosed herein. The magnetic flux yokes may also be made from pressed sintered pure iron powder or from ferrous powder.

The ring cylinder segments may be identical parts. This reduces the manufacturing expenditures. Because the segments are more compact than a complete magnet yoke ring, the manufacture of the segments to the pressing method necessitates only press equipment of lower compacting pressure.

When the stator carries the coil arrangement and the rotor is provided with the permanent magnet elements, this eliminates the necessity of moving (e.g. rotating) current transfers to a coil arrangement in the rotor.

The air gap between the magnetic flux poles and the permanent magnet elements may range from approx. 0.1 mm to approx. 1.5 mm or more, with any intermediate values being considered as disclosed herein.

The lateral areas of the magnetic flux yokes may have mutually spaced webs which form the magnetic flux poles. Webs of a magnetic flux yoke may be arranged at such a distance from each other that they and correspondingly shaped webs of an oppositely located magnetic flux yoke engage like fingers of two hands. Webs of a magnetic flux yoke may have an essentially rectangular parallelepiped shape. It is also possible to make them tapering in the width and/or height direction towards their ends. This shaping reduces or minimised the magnetic the magnetic leakage fluxes between neighbouring webs of the magnetic flux yokes.

Each magnetic flux yoke has an essentially plane bottom area with a central opening for arranging each magnetic flux yoke secured against rotation on a stator carrier. For this purpose, the cross-section of the opening is not circular, and the cross-section of the stator carrier is designed as a cylinder of an approximately complementary shape. The stator carrier is a cylindrical tube which fowled from a magnetically non-effective material (e.g. aluminium or the like).

The permanent magnet elements may be formed as pressed parts, castings or sheet metal blanks form an AlNi or AlNiCo alloy, from barium or strontium ferrite, from an SmCo or NdFeB alloy. Thereby, energy products (BH)ₘₐₓ of permanent magnets ranging from approx. 30 to approx. 300 kJ/m³—even in the higher temperature range from approx. 150 to approx. 180° C.—can be achieved.

The permanent magnet elements may also be formed as components from magnetic powder particles which are embedded in temperature resistant plastic binders including e.g. polyamide, polyphene sulfide, thermosetting plastic, epoxy resin, or the like. The plastic binder may also be methacrylate adhesive, epoxy resin adhesive, polyurethane adhesive, phenolic resin adhesive, fibre-reinforced epoxy resin or hydrophobised epoxy cast resin.

The permanent magnet elements may also have an essentially parallelepiped shape. They may be of a shape which essentially corresponds to the shape of the webs of the magnetic flux yokes; in a plan view, they may therefore have a rectangular, trapezoidal or triangular or rhombic shape, respectively, or the like towards the air gap. In order to achieve an air gap of an essentially constant gap dimension, the contour of the magnetic flux yokes (concave or convex) may be complementarily formed into permanent magnet elements.

In the housing of the axial flow machine or mounted at its outside, an electronic control unit may be provided which is to be connected with a current supply and to be fed with positional or angular set point signal, and which is to be connected with a rotational position or rotation angle detector which senses the rotation movements of the axial flow machine in order to appropriately drive the coil arrangement. A sensorless pole position detection is also possible.

The coil arrangement may be formed from enamelled copper wire, copper flat ribbons, or stranded copper wire consisting of enamelled single conductors which are twisted or braided together. Such stranded wires may counteract an increase in the conductor resistance at higher frequencies.

The coil arrangement may be housed in magnetically non-effective coil body (e.g. of plastic material) which comprises a connecting channel which extend to an electronic circuit board inside or outside the axial flow machine. This considerably facilitates the assembly.

Each of the magnetic flux yokes may comprise several neighbouring magnetic flux poles which are arranged equally spaced along the circumference, with the exception of one place where no magnetic flux pole is provided. Instead of a missing magnetic flux pole, several magnetic flux poles and/or parts of a magnetic flux pole may be omitted, depending on the space requirement of the connecting channel or the connecting line, respectively, in the circumferential direction. This configuration allows guiding the connecting channel at the place where the magnetic flux pole is missing from the plastic coil body between the magnetic flux poles to the electronic circuit board.

Further, a method is presented for the manufacture of a rotor of an electrical axial flow machine with permanent magnet elements. This method comprises the following steps:

Providing a soft magnetic support body;
applying a matrix which defines the position of the permanent magnet elements on the support body;
inserting the permanent magnet elements into the matrix on the support body;
coating of the support body and the permanent magnet elements with a magnetically non-effective support layer which comprises at least one layer which at least partially accommodates the permanent magnet elements; and removing the support body.

The application step of a matrix which defines the position of the permanent magnet elements on the support body may comprise the application of a grid, e.g. of wax, plastic material, or the like. If the grid is made of plastic material, paper, carton, or the like, the permanent magnet elements may have already been inserted in the matrix upon its application, or may subsequently be inserted into the matrix in a placing step, when it is already arranged on the support body.

Thereby, the matrix may define the position of the permanent magnet elements both in the circumferential direction and the longitudinal direction of the support body. It is also possible that the matrix defines the position of the permanent magnet elements only in the longitudinal direction of the support body, while the position of the permanent magnet elements in the circumferential direction adjusts itself, because the permanent magnet elements mutually repel each other and thereby slide on the soft magnetic support body in the circumferential direction and assume equally spaced positions. This requires a low-friction contact between the permanent magnet elements and the soft magnetic support body.

The step of removing the support body may comprise the loss of the matrix.

The application step of the matrix on the support body may comprise the application of a matrix which defines the position of the permanent magnet elements in the axial direction and/or in circumferential direction of the support body.

In another variant, the permanent magnet elements are not inserted as individual magnet elements into the matrix on the support body. Rather, either rings or bars are provided with alternating magnetisation in their (circumferential or longitudinal, respectively) extension, so that handling and mounting are simplified. Regardless of whether single magnet elements or alternately magnetised rings or bars are involved, they may be magnetised with corresponding polarisation only immediately prior to their assembly on the support body in a portion or zone-wise manner.

In order to provide the high magnetic field strengths which are required for the magnetisation, inductors are needed which are able to carry high current densities with small installation space or lateral dimensions, respectively. Due to the fact that conventional copper inductors are hardly able to meet these requirements, copper wires may be used which are attached on a ceramic carrier, e.g. made of silicon nitride. The ceramic carrier may be cooled very efficiently at the side facing away from the copper wires or by internally routed cooling channels. Such an arrangement enables to realise the magnetisation of very fine structures, i.e. of a very fine pole pitch (numerous north-south magnets per section unit).

### BRIEF DESCRIPTION OF THE FIGURES

Additional features, properties, advantages, and possible modifications will become apparent for those with skill in the art from the following description which also refers to the accompanying drawings.

FIG. 1 is a schematic longitudinal section of an axial flow machine.

FIG. 2 is a schematic lateral partial illustration of magnetic flux yokes.

FIG. 3 is a schematic perspective illustration of a ring cylinder segment of a magnetic flux yoke.

FIG. 4 is a schematic plan view of a magnetic flux yoke.

FIG. 5 is a schematic bottom view of a magnetic flux yoke.

FIG. 6 shows an enlarged schematic sectional view of a magnetic flux yoke with two segments fitted into one another and a coil arrangement housed therein.

FIG. 7 shows a schematic perspective illustration of a support disk.

FIG. 8 is a schematic sectional view through two neighbouring magnetic flux yokes with two each segments fitted into one another and coil arrangements housed therein, with the segments of the magnetic flux yokes being held by support disks on a carrier tube.

### DETAILED DESCRIPTION OF THE EMBODIMENTS

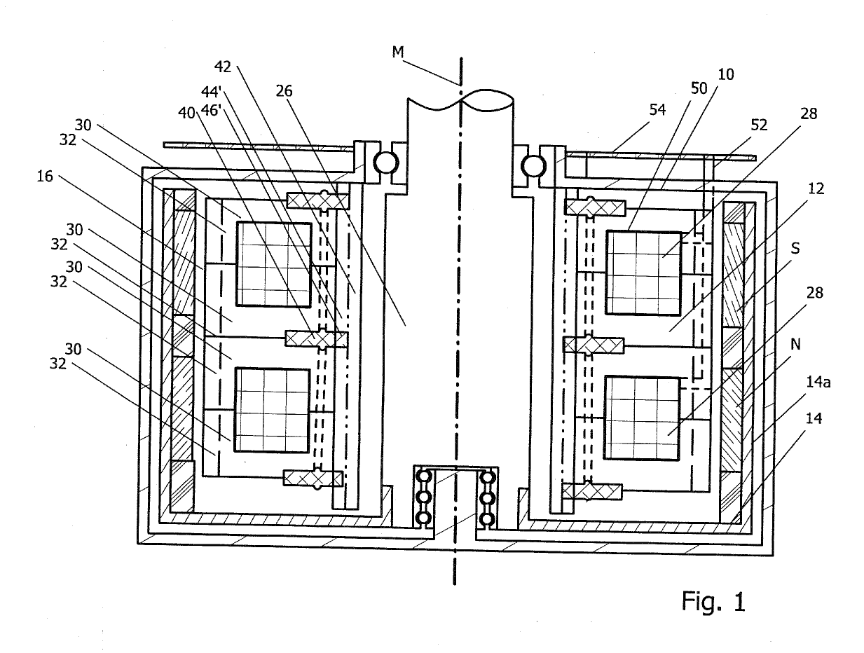

FIG. 1 shows an electrical machine which is designed as an axial flow machine of the external rotor type. The axial flow machine 10 has a stator 12 and a rotor 14. The rotor 14 has a cup-shaped carrier 14a for permanent magnet elements N, S. The stator 12 has several (two shown herein) coil arrangements 28. Each coil arrangement 28 of the stator 12 has a ring cylindrical winding and is encompassed by two essentially annular magnetic flux yokes 30. Each of the annular magnetic flux yokes 30 has lateral areas with magnetic flux poles 32. The outsides of the magnetic flux poles 32 are oriented towards the permanent magnet elements N, S of the rotor 14.

A ring cylindrical air gap 16 is formed between the rotor 14 and the stator 12. The magnetic orientation of neighbouring permanent magnet elements N, S of the rotor 14 towards the air gap 16 is alternating. The permanent magnet elements N, S are oriented in alignment with the magnetic flux poles 32 of the rotor 12 in certain positions of the rotor 12 relative to the stator 14. Here, the permanent magnet elements are made e.e. from an SmCo or NdFeB alloy. The magnetic flux yokes 30 comprise several segments and are formed as pressed/sintered parts from pure iron powder. An output shaft 26 is connected with the rotor 14 so as to be secured against rotation, e.g. by welding.

As can be seen from the figures, the magnetic flux yokes 30 have an approx. U-shaped cross-section with outer and inner lateral areas 32, 34 which together with a plane connecting 36 located in between, generate the U-shaped section. In the present variant, the outer lateral areas of the magnetic flux yokes 30 are formed as a plurality of spaced webs at their circumference, which form the magnetic flux poles 34. The webs 34 of a magnetic flux yoke 20 are arranged at such a distance from each other that they and correspondingly shaped webs 34 of an oppositely located magnetic flux yoke 30 that they engage finger- or clawlike and encompass and surround the coil arrangement 28 at its outside. Each magnetic flux yoke 30 has an essentially plane bottom area 36 with a central opening 38. To improve the mechanic stability of the overall arrangement, a wedge-shaped ring 48 of a resilient plastic material may be inserted adjacent to the coil arrangement 28 between the magnetic flux yokes 20, which is compressed during the assembly in the axial direction (see FIG. 6).

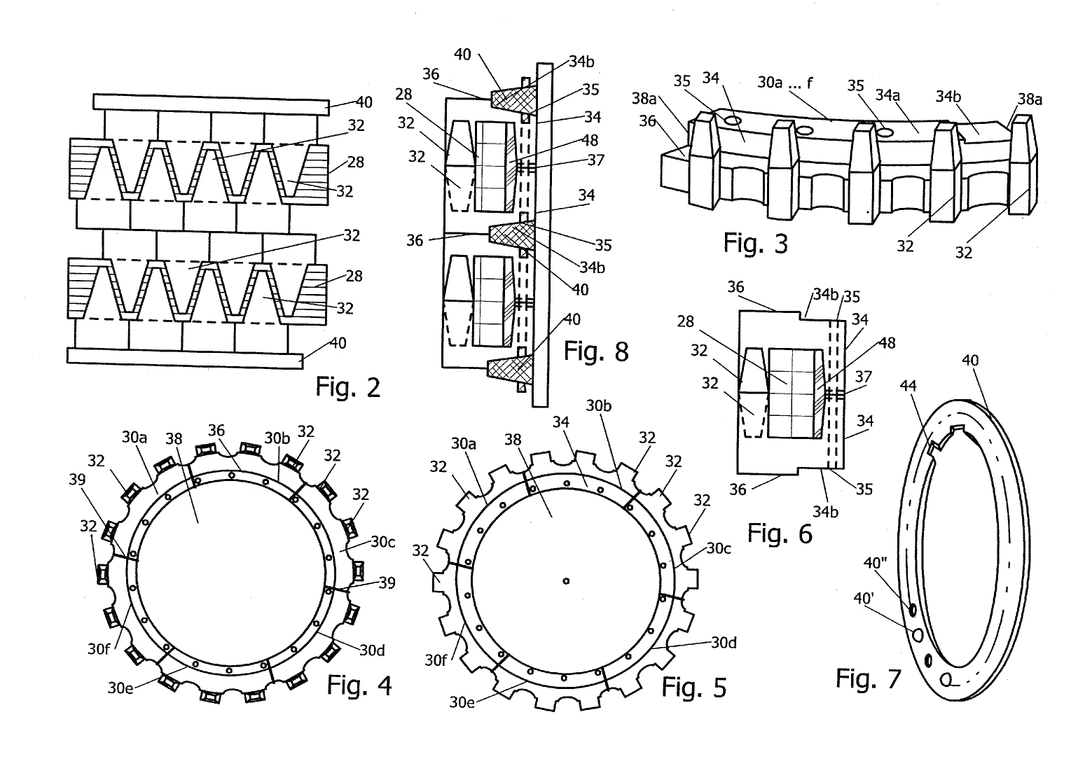

Each of the annular magnetic flux yokes 30, 30′ is formed from several—in this example six-ring cylinder segments 30a, 30b, . . . 30f (see FIGS. 2, 3). Between neighbouring magnetic flux yokes 30, 30′ one support disk 40 each is arranged for the ring cylinder segments 30a, 30b, . . . 30f of the magnetic flux yokes. The support disk 40 is provided with means in the form of recesses, projections 40′ or indentations 40″. FIG. 7 shows only a few of the projections 40′ or indentations 40″ which are provided at each support disk 40 equally spaced along the entire circumference at the top and bottom side. In the assembled condition of the support disk with the magnetic flux yokes, they extend into correspondingly dimensioned recesses 35 of the ring cylinder segments 30a, 30b, 30f and serve to mechanically position the ring cylinder segments 30a, 30b, . . . 30f in the radial and the circumferential direction. One support disk 40 each is also arranged at the two end faces of the stack of magnetic flux yokes 30, 30′.

In order to ensure a high mechanical stability of the overall arrangement of the magnetic flux yokes 20, 20′, each support disk 40 is designed as a continuous circular disk. For the satisfactory heating of the magnetic flux yokes 20, 20′—and of the coil arrangements 28 surrounded by them—during operation, the support disks 40 are made from a material with good thermal conductivity, such as aluminium or the like. In addition, the support disks 40 are made from a magnetically non-effective or only slightly effective material—with aluminium being again well suited for this purpose. Finally, the support disks 40 are arranged between two magnetic flux yokes 20, 20′ each which encompass different coil arrangements 14, 14′. Because the aluminium support disk 40 is anodized, it has an additional electrically insulating effect. The support disk 40 may also be coated with plastic material, enamel, glass, or another electrically insulating substance but with good thermal conductivity. It is also possible to coat the magnetic flux yokes 20, 20′ with one of these substances, or to insert a separate insulating layer between the magnetic flux yokes 20, 20′ and the support disk 40.

Each support disk 40 is arranged secured against rotation at a carrier 42 which in the illustrated variant is a carrier tube 42. In the variant shown in FIG. 7, a groove 44 in the support disk 40, into which a complementarily shaped projection at the (inner or outer) circumference of the carrier (tube) 42 engages is provided for securing purposes. Alternatively (see FIG. 1), a longitudinal groove 44′ in the carrier 42 may be provided into which a complementarily shaped projection 46′ engages at the (inner or outer) circumference of the support disk 40.

The carrier tube 42 is equipped with channels 50 for the passage of a cooling fluid so that the heat losses via the support disks 40 may be dissipated from the magnetic flux yokes 20. For this purpose, the support disk 40 is in an intimate heat-conducting contact with the magnetic flux yokes 20 without significantly affecting the magnetic flux conductance through the magnetic flux yokes 20. In the shown variant, the support disk 40 extends in the radial direction approx. ⅓ of the radial extension of the ring cylinder segment 20 from the carrier tube wall. In the variant illustrated herein, the support disk has an essentially rectangular cross-section. To improve the heat transition from the support disk to the carrier tube wall, the cross-section of the support disk may also be wedge-shaped, with the flank of the support disk, which faces the carrier tube wall being larger than the flank which extends between the magnetic flux yokes 20 (see FIG. 8).

Each of the ring cylinder segments 30a, 30b, . . . 30f has an end face 34a at its radially inner lateral area 34, into one end of which a step 34b is formed (see FIG. 3). With the end faces 34a facing one another in the assembled condition of the ring cylinder segments, an intermediate space 37 is generated between the respective end faces 34a. Each of the ring cylinder segments has two lateral faces 38a, 38b which in the circumferential direction of the magnetic flux yoke 20 face another one of the ring cylinder segments. The lateral faces 38a, 38b of two adjacent ring cylinder segments are electrically insulated against one another by an air gap 39 which is provided between them. After the ring cylinder segments with the coil arrangements accommodated therein have been completely assembled, the air gaps and the intermediate spaces 37, but also other cavities in the arrangement, may be filled with resin or adhesive.

The ring cylinder segments are made as identical parts. Ring cylinder segments whose magnetic flux yokes are in a finger-like engagement partially overlap one another with their respective end faces in the circumferential direction of the magnetic flux yokes (approximately in a brickwork fashion), which further increases the mechanical stability of the overall arrangement.

The permanent magnet elements N, S are formed from a magnetic material and have an essentially rectangular parallelepiped shape.

The coil arrangement is wound as a ring cylinder coil from stranded wires which consist of twisted or braided enamelled single conductors, in a plastic coil body 50. The coil body 50 has a connecting channel 52 which extends from the outside of the coil body 50 to an electronic control circuit board 54 outside the axial flow machine. One magnetic flux pole each is missing at the same place along the circumference of the magnetic flux yokes. There, the connecting channel 52 leads from the plastic coil body 50 between the magnetic flux poles to the electronic control circuit board 54.

For making the coil arrangement, stranded wires consisting of enamelled twisted or braided single conductors may be used. This counteracts in increase in the conductor resistance at higher frequencies. Eddy currents are generated in an electrical conductor by the magnetic fields of the alternating current, which counteract the current flow. These eddy currents increase with increasing frequencies. Thus, a frequency-dependent alternating current equivalent resistance is added to the direct current resistance. The eddy current losses are highest at the bottom of the groove formed by the magnetic flux yokes and decrease outwards towards the air gap. In order to keep the above mentioned losses as low as possible the conductor cross-section is reduced which causes lower eddy current losses and instead includes several conductors in parallel. In order to compensate for the current asymmetry of the individual conductors, the conductors are twisted or stranded. Twisting is selected in such a manner that the position of a wire uniformly alternates between the groove bottom and the groove opening over the length of the stranded wire.

The cross-section of the individual conductors should decrease with increasing frequency; in the range around 1 kHz the individual wire's cross-section should amount to approx. 0.4 mm. In order to improve the space filling factor (volume of the winding space in relation to the volume of the electrical conductors), preferably stranded wires with a rectangular cross-section are used. The space filling factor gain results from the compaction of the stranded wire, and the more efficient filling of the winding space due to the rectangular geometry. The single conductor may have one or several spin overs/braidings with different threads, e.g. polyamide, cotton, glass, polyester, aramide, etc. Moreover, one or several bandages with polyester foils, polyimide foils, aramide paper, glass ribbons, etc. may be employed. Insulation layers of adhesive-coated foils such as polyester and polyimide are heat-treated in order to achieve a well bonded insulation. Combinations of the above mentioned measures may also be implemented. Instead of the stranded wires, the winding may be formed by a solid copper ribbon. In this case, too, the wire may be twisted. The copper ribbon should be thin in the direction of the groove.

For the manufacture of a permanent magnet arrangement for the above described electrical axial flow machine it is proposed to provide a magnetically effective cylindrical support body, e.g. an iron tube. Depending on whether the permanent magnet arrangement in the axial flow machine is to rotate as an external rotor or an internal rotor configuration, the outer diameter or the inner diameter of the tube is to be matched to the diameter of the magnetic flux yokes including the air gap. Then a matrix which defines the position of the permanent magnet elements in the axial direction and/or in the circumferential direction is applied to the inner or outer wall of the tube of the support body. This matrix may be made from wax, paper, plastic material, or the like. The permanent magnet elements have either been already inserted in an alternating—chess board type—orientation into the matrix upon its application on the den support body, or the permanent magnet elements may alternatively be inserted into the matrix when it is already disposed on the support body.

Subsequently, the support body with the matrix and the permanent magnet elements is covered by a magnetically non-effective support layer comprising at least one layer, which accommodates the permanent magnet elements at least partially. To this effect, the assembled carrier tube may be placed in an (injection) mould which either surrounds the carrier tube or is inserted into same, depending on whether an external or internal rotor configuration is involved. Then the support layer is applied (cast or injection moulded). After hardening, the carrier tube is separated from the (injection) mould and the hardened support layer with the permanent magnet elements is removed from the support body. This means that the matrix is designed as an investment casting.

In one variant, the matrix defines the position of the permanent magnet elements both in the circumferential direction and in the longitudinal direction of the support body. In another variant, the matrix defines the position of the permanent magnet elements in only the longitudinal direction of the support body. In this variant, the position of the permanent magnet elements in the circumferential direction adjusts itself, because the permanent magnet elements mutually repel each other and thereby slide on the soft magnetic support body in the circumferential direction. The contact between the permanent magnet elements and the soft magnetic support body is therefore of a low-friction nature, which is realised by applying a friction-reducing coating (tetrafluoroethylene or the like) on e.g. the support body.

In another variant, the permanent magnet elements are not inserted as individual magnet elements into the matrix on the support body, but in the form of rings are provided with an alternating magnetisation in the circumferential extension. The individual rings are then slipped on the support body or inserted into the support body. As an alternative for the rings, elongated bars or helical portions may be used. The individual magnet elements or the magnetised rings or bars may be magnetised with a corresponding polarisation portion or zone-wise immediately prior to their assembly at the support body.

For this purpose, inductors are employed which are capable of carrying high current densities with small installation space or lateral dimensions, respectively. These inductors comprise copper wires which are attached on a ceramic carrier, e.g. made of silicon nitride. The ceramic carrier may be cooled at the side facing away from the copper wires (by means of water, oil, liquid nitrogen, or the like). This allows the realisation of a very fine pole pitch of the magnet elements.

Though the above explained details are presented in a certain context, they are, however, independent from one another and may be freely combined.

The relationships of the individual parts and portions thereof illustrated in the figures as well as their dimensions and proportions are not to be understood as limiting. Rather, individual dimensions and proportions may differ from those shown.

1. An electrical axial flow machine, comprising a stator and a rotor, wherein;
either the stator comprises a coil arrangement and the rotor is provided with permanent magnet elements (N, S), or the rotor comprises a coil arrangement and the stator is provided with permanent magnet elements;
the stator is arranged spaced from the rotor under the formation of an air gap;
each of the magnetic flux yokes comprises several neighbouring magnetic flux poles;
the coil arrangement comprises at least one hollow cylindrical winding which is at least partially encompassed by magnetic flux yokes;
the magnetic flux yokes are formed from several ring cylinder segments;
a support disk each for the ring cylinder segments of the magnetic flux yokes is arranged between neighbouring magnetic flux yokes in the direction of a longitudinal centre axis (M) of the magnetic flux yokes;
wherein;
the support disk
comprises means for the mechanical positioning of at least two ring cylinder segments, and
forms a thermal path to a heat sink, with
an electrically insulating layer being arranged between the support disk and each ring cylinder segment positioned thereon.

2. The electrical axial flow machine according to claim 1, wherein the insulating layer is either disposed at the support disk or at the ring cylinder segment, or is disposed between the support disk and the ring cylinder segment as an electrically insulating layer.

3. The electrical axial flow machine according to claim 1, wherein each support disk;
is formed as a continuous circular disk from a material with good thermal conductivity, such as aluminium or the like, or
is formed from a magnetically non-effective or only slightly effective material, or
is arranged between two magnetic flux yokes, each of which encompassing different coil arrangements.

4. The electrical axial flow machine according to claim 1, wherein each support disk;
is arranged at a carrier secured against rotation; or
comprises recesses, projections, or indentations as means for the mechanical positioning of the ring cylinder segments for the positive and/or non-positive connection, which are designed for cooperation with complementarily shaped means at the ring cylinder segments.

5. The electrical axial flow machine according to claim 1, wherein the heat sink is arranged in the carrier and designed as a fluid cooling system, a Peltier element arrangement, or the like.

6. The electrical axial flow machine according to claim 1, wherein each of the ring cylinder segments comprises a mounting place for at least one portion of the respective support disk, with the mounting place being dimensioned and arranged at the ring cylinder segment in such a manner that cooling of the ring cylinder segment is enabled and/or the magnetic flux in the direction of a longitudinal centre axis (M) of the magnetic flux yokes through these is at least essentially unaffected.

7. The electrical axial flow machine according to claim 1, wherein the support disk covers approx. 10% to approx. 80%, preferably approx. 25% to approx. 40% of the radial extension of the ring cylinder segments in the radial direction.

8. The electrical axial flow machine according to claim 1, wherein each of the ring cylinder segments comprises an end face which faces at least another one of the ring cylinder segments, and wherein the end face comprises a step, so that an intermediate space is formed between the respective end faces, with the ring cylinder segments facing each other.

9. The electrical axial flow machine according to claim 1, wherein each of the ring cylinder segments comprises two lateral faces which in circumferential direction des magnetic flux yokes face at least one of the other ring cylinder segments, and wherein die lateral faces of two adjacent ring cylinder segments are electrically insulated against each other.

10. The electrical axial flow machine according to claim 1, wherein the ring cylinder segments are formed as identical parts, and wherein the ring cylinder segments are formed so as to at least partially encompass the coil arrangement and are oriented towards one another to partially overlap each other with their end faces in the circumferential direction of the magnetic flux yokes.

11. The electrical axial flow machine according to claim 1, wherein the ring cylinder segments are pressed from ferrous powder.

12. The electrical axial flow machine according to claim 1, wherein the permanent magnet elements (N, S) are formed from an AlNi or AlNiCo alloy, from barium or strontium ferrite, from an SmCo or NdFeB alloy, also embedded in plastic binders including polyamide, polyphene sulfide, thermosetting plastic, epoxy resin, or the like.

13. The electrical axial flow machine according to claim 1, wherein the permanent magnet elements (N, S) comprise an essentially parallelepiped shape.

14. The electrical axial flow machine according to claim 1, wherein the coil arrangement is formed from stranded wires consisting of twisted or braided enamelled single conductors.

15. The electrical axial flow machine according to claim 1, wherein the coil arrangement is housed in a magnetically non-effective coil body which comprises a connecting channel which extends to an electronic circuit board inside or outside the axial flow machine.

16. The electrical axial flow machine according to claim 1, wherein each of the magnetic flux yokes comprises several neighbouring magnetic flux poles which are arranged equally spaced along the circumference with the exception of one place where a magnetic flux pole is missing, so that at the place where the magnetic flux pole is missing the connecting channel leads from the plastic coil body between the magnetic flux poles to the electronic circuit board.

17. A method for the manufacture of a rotor of an electrical axial flow machine with permanent magnet elements, comprising the steps:
providing a soft magnetic support body;
applying a matrix which defines the position of the permanent magnet elements on the support body;
inserting the permanent magnet elements into the matrix on the support body;
coating of the support body and the permanent magnet elements with a magnetically non-effective support layer which comprises at least one layer which at least partially accommodates the permanent magnet elements, and
removing the support body.

18. The method for the manufacture of a rotor of an electrical axial flow machine, comprising the steps of claim 17, wherein the application step of a matrix which defines the position of the permanent magnet elements on the support body comprises the application of a grid of paper, wax, plastic material, or the like.

19. The method for the manufacture of a rotor of an electrical axial flow machine, comprising the steps of claim 17, wherein the step of removing the support body from the permanent magnet arrangement includes the loss of the matrix.

20. The method for the manufacture of a rotor of an electrical axial flow machine, comprising the steps of claim 17, wherein the applying step of the matrix on the support body comprises the application of a matrix which defines the position of the permanent magnet elements in the axial direction and/or in circumferential direction of the support body.

21. The method for the manufacture of a rotor of an electrical axial flow machine, comprising the steps of claim 17, wherein the matrix defines the position of the permanent magnet elements both in the circumferential direction and the longitudinal direction of the support body, or wherein the matrix defines the position of the permanent magnet elements in one (longitudinal) direction of the support body, while the position of the permanent magnet elements in another (circumferential) direction adjusts itself, in that the permanent magnet elements mutually repel each other and thereby slide on the soft magnetic support body in the circumferential direction.

22. The method for the manufacture of a rotor of an electrical axial flow machine, comprising the steps of claim 17, wherein the permanent magnet elements as rings are provided in the circumferential direction with alternating magnetisation, and wherein the individual rings are then slipped on the support body or are inserted into the support body.

23. The method for the manufacture of a rotor of an electrical axial flow machine, comprising the steps of claim 17, wherein the permanent magnet elements are designed as elongated bars or helical portions which are magnetised portion or zone-wise with the corresponding polarisation prior to their assembly at the support body.

24. The method for the manufacture of a rotor of an electrical axial flow machine, comprising the step of claim 23, wherein the permanent magnet elements are prepared by means of inductors which have copper wires disposed on a ceramic carrier of silicon nitride, and whose ceramic carrier is cooled at the side facing away from the copper wires.
